(19) United States
(12) Patent Application Publication
(10) Pub. No.: US 2018/0033530 A1
(43) Pub. Date: Feb. 1, 2018

(54) MAGNETIC COMPOUND, ANTENNA, AND ELECTRONIC DEVICE

(71) Applicant: DOWA ELECTRONICS MATERIALS CO., LTD., Tokyo (JP)

(72) Inventors: Toshihiko UEYAMA, Tokyo (JP); Masahiro GOTOH, Tokyo (JP); Takayuki YOSHIDA, Tokyo (JP); Takuyuki BABA, Tokyo (JP)

(73) Assignee: DOWA ELECTRONICS MATERIALS CO., LTD., Tokyo (JP)

(21) Appl. No.: 15/552,415

(22) PCT Filed: Feb. 24, 2016
(86) PCT No.: PCT/JP2016/055367

§ 371 Date: Aug. 21, 2017

(30) Foreign Application Priority Data
Feb. 25, 2015 (JP) 2015-035902
Jun. 2, 2015 (JP) 2015-112705

(51) Int. Cl. H01F 1/26; C08L 71/12; C08L 25/06; C08K 3/08; C08K 9/04

(52) U.S. Cl. CPC H01F 1/26; C08K 3/08; C08K 9/04; C08L 25/06; C08L 71/12

(57) ABSTRACT

An object of the present invention is to provide a magnetic compound excellent in high-frequency property and excellent in mechanical strength and related materials thereof by using at least one of resins selected from syndiotactic polystyrene (SPS) resin and modified polyphenylene ether (m-PPE) resin, including at least one of resins selected from syndiotactic polystyrene (SPS) resin and modified polyphenylene ether (m-PPE) resin, wherein content of the resin is 21 mass % or more.

### TECHNICAL FIELD

The present invention relates to a magnetic compound, an antenna and an electronic device.

### DESCRIPTION OF RELATED ART

In electronic devices and communication devices, development of various materials is prosperous in order to respond to various functions of the market. Among all, in equipment used for high-frequency regions, etc., performance of a communication device is affected by a composite functional material, and therefore it is an important technical element.

For example, patent document 1 discloses a magnetic composite material that functions even in a high-frequency region. This magnetic composite material is formed, preferably in such way that magnetic metal particles having an acicular shape with an aspect ratio (major axis length/minor axis length) of 1.5 to 20 are dispersed in a dielectric material such as polyarylene ether resin or polyethylene resin (claim 1 or 2, or [0025] of patent document 1).

With this structure, the magnetic composite material is suitably used for high-frequency electronic components to be installed in an electronic device and a communication device used in the high-frequency region of a GHz band, and in addition, by using predetermined acicular metal particles, a predetermined magnetic property can be obtained regardless of whether or not the metal particles are oriented in the dielectric material ([0024], [0029] of patent document 1).

Further, patent document 2 discloses a composite magnetic material that can be used for a small antenna usable in a broad band. This composite magnetic material is the material in which a composite magnetic material is dispersed in an insulating material. The magnetic powder is a substantially spherical powder containing a soft magnetic metal, with its average particle size D₅₀ of 0.1 to 3 μm, and having crystallites with an average crystallite size of 2 to 100 nm in the particles, and discloses various resins as the insulating material ([0018] to [0021] of patent document 2). For example, according to examples, an antenna is made by mixing a magnetic powder, a thermoplastic PC/ABS resin, a solvent and the like ([0069]). Also, patent document 2 discloses that in this antenna, loss factor tan δε of a dielectric constant at a frequency of 2 GHz is less than 0.01, and a volume ratio of the magnetic powder with respect to a total volume is 2 to 50 vol %, and with this structure, miniaturization of antenna can be achieved ([0031] to [0032] of patent document 2).

Patent document 3 discloses that owing to the metal magnetic powder, the loss factor in the GHz band in inductors and antennas, etc. can be suppressed to be low. Also, patent document 3 discloses that the metal powder is a soft magnetic metal powder mainly composed of iron, and such a metal powder having an average particle size of 100 nm or less, an axial ratio (=major axis length/minor axis length) of 1.5 or more, a coercive force (Hc) of 39.8 to 198.9 kA/m (500 to 2500 Oe) and saturation magnetization of 100 Am²/kg or more is molded, wherein the magnetic component is capable of suppressing the loss factor in the kHz to GHz band to be low ([0011] to [0026] of patent document 3).

Patent document 4 discloses that a magnetic powder, a polyphenylene sulfide (PPS) resin and a polyamide (PA) resin are contained in a bonded magnet having heat resistance, wherein the content percentage of the magnet powder in the compound is 79 to 94.5 wt %, the content percentage of the PPS resin is 5 to 20 wt %, and the content percentage of the PA resin is 0.1 to 2 wt % (claim 1 of patent document 4).

As described above, there is a disclosure regarding a magnetic composite (or also referred to as a magnetic compound) composed of a metal magnetic powder and a resin. However, in the magnetic compound composed of a metal magnetic powder and a resin material, the metal magnetic powder is made of fine particles of an inorganic compound, and the resin is made of a polymer compound. In other words, the metal magnetic powder and the resin have completely different chemical properties and physical properties, and therefore it is difficult to predict what kind of performance it is, and various trial and error are required as in the prior art.

### PRIOR ART DOCUMENT

### Patent Document

[Patent Document 1] Japanese Unexamined Patent Publication No. 2014-116332
[Patent Document 2] Japanese Unexamined Patent Publication No. 2011-096923
[Patent Document 3] Japanese Unexamined Patent Application Publication No. 2013-236021
[Patent Document 4] Japanese Unexamined Patent Application Publication No. 2013-077802

### SUMMARY OF THE INVENTION

### Problem to be solved by the Invention

It is desired to improve properties of a magnetic compound prepared by kneading a metal magnetic powder and a resin material, etc., in accordance with a request for higher performance of an electronic device, and meanwhile, it is also desired to improve a mechanical strength in accordance with a request for a miniaturization.

Patent documents 1 to 4 disclose a magnetic compound (composite magnetic material) of a magnetic material and a resin material in which a content percentage of the magnetic material is high. However, in accordance with an improvement of a performance of the magnetic material achieved by studies of an applicant, sufficient high-frequency property has been obtained even if the content of the magnetic material in the compound is reduced to some extent. However, when such a magnetic powder is dispersed in a resin, ignition occurs in the kneading stage, or a remarkable reduction of strength occurs as compared with a case in which the magnetic powder is not added. That is, a compound material that satisfies both mechanical strength and high-frequency property has not yet been obtained.

For example, patent document 4 discloses that other unexpected effect occurs in some cases during kneading and molding due to poor wettability of PPS resin and the magnet powder. Although syndiotactic polystyrene (SPS) resin and modified polyphenylene ether (m-PPE) resin are excellent in high-frequency property, it is confirmed that kneading with the metal magnetic powder is difficult.

On the other hand, in response to the miniaturization, materials with better bending strength and toughness have been desired in order to withstand interference with thinner lines, flexible substrates, and other components. Patent Document 1 exemplifies that various resins can be used. However, polyethylene resin shown as an example is weak in the bending strength of about 6.9 MPa even in a case of a high density resin which is considered to have a relatively high mechanical strength. Therefore, it is difficult to use such a polyethylene resin in a real environment where shocks are easily added. It is confirmed that syndiotactic polystyrene (SPS) resin and modified polyphenylene ether (m-PPE) resin have a bending strength of 60 Mpa or more and elastic modulus of about 1900 Mpa, and improvement of the mechanical strength can be expected.

An object of the present invention is to provide a magnetic compound excellent in high-frequency property and excellent in mechanical strength, using at least one of syndiotactic polystyrene (SPS) resin and modified polyphenylene ether (m-PPE) resin, and provide an antenna composed of this magnetic compound, and an electronic device using this antenna.

### Means for solving the Problem

According to the knowledge of inventors of the present invention, when an antenna is made of a material in which a metal magnetic powder is mixed into a resin, the antenna itself can be miniaturized by a wavelength shortening effect, thereby contributing to the miniaturization of portable devices and smartphones.

Conventionally, as typified in patent document 1, as a magnetic compound material used for the antenna or, etc., studies have been limited only to a metal material even in a structure in which the metal magnetic powder is mixed into resin.

In contrast, the inventors of the present invention further study on a point that there is a clue capable of solving the abovementioned problem, not in the metal magnetic powder mixed into resin and capable of exhibiting properties, but in the resin which is a target to be mixed with the metal magnetic powder.

First, as the resin which can be a target to be mixed, the inventors of the present invention consider that it is a shortcut to select a material excellent in a mechanical property (particularly bending strength), with a small loss of the resin itself. However, it is found that burning occurs by ignition of the metal magnetic powder, when trying to mix the metal magnetic powder disclosed in patent document 3 into resin which is a target to be mixed, as described above. Further, as a method, it is conceivable to increase the ratio of resin so as to seal the metal magnetic powder with resin to prevent ignition. However, the ratio of the metal magnetic powder is naturally decreased and magnetic permeability of the magnetic compound itself is decreased, and therefore it is considered that the antenna is not operated sufficiently as an antenna. Therefore, a method of mixing the metal magnetic powder into resin is taken into consideration.

The present invention has the following aspects.

A first aspect of the present invention is a magnetic compound, including:

a metal magnetic powder; and

one or more resins selected from syndiotactic polystyrene (SPS) resin and modified polyphenylene ether (m-PPE) resin,

wherein the metal magnetic powder is coated with one or more coating substances selected from dicarboxylic acid, dicarboxylic acid anhydride and a derivative thereof so that a part or the whole part of a surface of the metal magnetic powder is coated, and

content of the resin is 21 mass % or more.

A second aspect of the present invention is a magnetic compound, including:

a metal magnetic powder; and

a resin,

wherein the resin is one or more resins selected from syndiotactic polystyrene (SPS) resin and modified polyphenylene ether (m-PPE) resin, and

the metal magnetic powder is coated with one or more coating substances selected from dicarboxylic acid, dicarboxylic acid anhydride and a derivative thereof so that a part or the whole part of a surface of the metal magnetic powder is coated.

A third aspect of the present invention is a magnetic compound, including:

a metal magnetic powder; and

one or more resins selected from syndiotactic polystyrene (SPS) resin and modified polyphenylene ether (m-PPE) resin,

wherein the metal magnetic powder is coated with one or more coating substances selected from dicarboxylic acid, dicarboxylic acid anhydride and a derivative thereof in a coating step, and

content of the resin is 21 mass % or more.

A fourth aspect of the present invention is a magnetic compound, including:

a metal magnetic powder; and

a resin,

wherein the resin is one or more resins selected from syndiotactic polystyrene (SPS) resin and modified polyphenylene ether (m-PPE) resin, and

the metal magnetic powder is coated with one or more coating substances selected from dicarboxylic acid, dicarboxylic acid anhydride and a derivative thereof in a coating step.

A fifth aspect of the present invention is the magnetic compound of any one of the first to fourth aspects, wherein the metal magnetic powder is formed so that a part or the whole part of the surface of the metal magnetic powder is coated with one or more coating substance selected from phthalic acid, maleic acid, phthalic anhydride, maleic anhydride, and a derivative thereof,

wherein the term “derivative” as used herein refers to a compound that has been modified to such an extent that it does not significantly alter a structure or properties of a parent body, such as introduction of a functional group, oxidation, reduction, substitution of atoms, and “substitution of atoms” includes substances whose ends are replaced with alkali metals and made soluble.

A sixth aspect of the present invention is the magnetic compound of the fifth aspect, wherein a measured value of carbon obtained by a high-frequency combustion method in a metal magnetic powder composite containing the metal magnetic powder and the coating substance is 0.1 mass % or more and 10 mass % or less.

A seventh aspect of the present invention is the magnetic compound of the fifth or sixth aspect, wherein the number of carbon atoms contained in one or more chemical structures selected from phthalic acid, phthalic anhydride, maleic acid, maleic anhydride, and a derivative thereof constituting the coating substance is 4 or more and 20 or less.

An eighth aspect of the present invention is the magnetic compound of any one of the first to seventh aspects, wherein when the magnetic compound is made by containing 30 Vol % of the metal magnetic powder composite prepared by adding 5 parts by mass of one or more substance selected from the phthalic acid, maleic acid, phthalic anhydride, maleic anhydride, and the derivative thereof to the resin, with respect to 100 parts by mass of the metal magnetic powder, a real part μ′ of magnetic permeability at a measurement frequency of 2 GHz is 1.5 or more and tan δ μ and tan δ ε are 0.05 or less.

A ninth aspect of the present invention is the magnetic compound of any one of the first to eighth aspects, wherein when the magnetic compound is measured at intervals of 0.05 GHz in a range of 0.75 GHz or more and 1.0 GHz or less, a standard deviation of the real part of the magnetic permeability and the real part ε′ of the dielectric constant is 0.01 or less.

A tenth aspect of the present invention is a magnetic compound including:

a metal magnetic powder; and

one or more resins selected from syndiotactic polystyrene (SPS) resin and modified polyphenylene ether (m-PPE) resin,

wherein content of the resin is 21 mass % or more, and

when the magnetic compound is made by containing 30 vol % of a metal magnetic powder composite composed of the metal magnetic powder and one or more coating substances selected from dicarboxylic acid, dicarboxylic acid anhydride and a derivative thereof, a real part μ′ of a magnetic permeability at a measurement frequency 2 GHz shows 1.5 or more and tan δμ and tan δε show 0.05 or less.

An eleventh aspect of the present invention is an antenna composed of the magnetic compound of any one of the first to tenth aspects.

A twelfth aspect of the present invention is the magnetic compound of any one of the first to tenth aspects, wherein the magnetic compound is obtained by mixing a metal magnetic powder and at least one of phthalic acid, phthalic anhydride, maleic acid, maleic anhydride, and a derivative thereof to form a metal magnetic powder composite, and thereafter kneading with resin.

A thirteenth aspect of the present invention is an electronic device including an antenna composed by the magnetic compound of any one of the first to tenth aspects and twelfth aspect.

### Advantage of the Invention

According to the present invention, a magnetic compound excellent in high-frequency property and excellent in mechanical strength and related materials can be provided by using at least one of resins selected from syndiotactic polystyrene (SPS) resin and modified polyphenylene ether (m-PPE) resin.

### DETAILED EMBODIMENT OF THE INVENTION

An embodiment will be described hereafter in the following order.

1. Magnetic compound
1-1. Metal magnetic powder
1-2. Coating substance
1-3. Resin

2. Method for producing a magnetic compound
2-1. Preparation step
2-2. Coating step
2-3. Kneading step with resin

3. Modified example, etc.

In this specification, “. . . to . . . ” means that it is not less than a predetermined value and not more than a predetermined value.

### 1. Magnetic Compound

The magnetic compound of this embodiment is composed of a metal magnetic powder, a coating substance, syndiotactic polystyrene (SPS) resin and modified polyphenylene ether (m-PPE) resin.

Each structure will be described hereafter.

### 1-1. Metal Magnetic Powder

The metal magnetic powder of this embodiment has the following structure as an example.

The metal magnetic powder having appropriately designed magnetic properties, particle diameter and the like may be used.

As magnetic properties, magnetic permeability and permittivity of the magnetic compound can be set by saturation magnetization (σs). In addition, coercive force (Hc), squareness ratio (SQ), and a particle size, shape, BET (specific surface area), TAP (tap) density as powder properties may be adjusted. For example, the metal magnetic powder of this embodiment contains Fe (iron), or Fe and Co (cobalt), and in addition rare earth element (including Y (yttrium), hereinafter the same), and at least one of Al (aluminum), Si (silicon), and Mg (magnesium) (hereinafter referred to as “Al., etc.”).

In an aqueous solution containing an element which is a raw material of the metal magnetic powder, by changing an amount of the rare earth element containing Y, it is possible to change the axial ratio (=major axis length/minor axis length) of finally obtained metal particles.

When the amount of the rare earth element is small, the axial ratio becomes large and a metal powder with reduced loss can be obtained. However, when the amount of the rare earth element is too small, the magnetic permeability is decreased. On the other hand, when the amount of the rare earth elements is large, the axial ratio becomes small and the loss becomes slightly large. However, the magnetic permeability becomes larger as compared with a case in which no rare earth element is contained.

Namely, by setting an appropriate rare earth content, the metal powder has high magnetic permeability with lower loss, and therefore it is possible to obtain the metal powder which can be used in a wide range of a conventional kHz to GHz band.

Here, as described above, in order to maintain the balance of properties, an appropriate content range of the element is preferably 0 at % (preferably more than 0 at %) to 10 at % as the content of the rare earth element with respect to the sum of Fe and Co, and more preferably greater than 0 at % and equal to or less than 5 at %. Further, Y and La are particularly preferable as the rare earth element species to be used.

When the metal magnetic powder contains Co, the Co content is 0 to 60 at % in terms of an atomic ratio of Co to Fe (referred to as “Co/Fe atomic ratio” hereafter). More preferably, the Co/Fe atomic ratio is 5 to 55 at %, and still more preferably 10 to 50 at %. In such a range, high saturation magnetization and stable magnetic property are easily obtained in the metal powder.

Further, Al, etc., also has a sintering suppressing effect, thereby suppressing coarsening of the particles due to sintering during heat treatment. In this specification, Al, etc., is treated as one of “sintering suppressing elements”. However, Al, etc., is a non-magnetic component, and if it is contained too much, the magnetic property is diluted, which is not preferable. The content of Al, etc., with respect to the sum of Fe and Co is preferably 1 at % to 20 at %, more preferably 3 at % to 18 at %, and still more preferably 5 at % to 15 at %.

The metal magnetic powder of this embodiment preferably has a core/shell structure composed of a core composed of a metal component and a shell mainly composed of an oxide component. Whether or not it has a core/shell structure can be confirmed by, for example, a TEM photograph, and methods such as ICP emission analysis, ESCA (aka XPS), TEM-EDX, SIMS and the like can be adopted for a composition analysis.

Particles of the metal magnetic powder are preferably nanoparticles having an average primary particle size of preferably 10 nm or more and 500 nm or less (preferably 100 nm or less). Even metal magnetic powder having a micro level (μm) size can be used, but from a viewpoint of improving communication characteristics and miniaturization, a smaller particle size is preferable.

Further, it is preferable to adjust a mixture so that the content of the metal magnetic powder in the magnetic compound is 50 vol % or less, preferably 40 vol % or less, more preferably 35 vol % or less. This is because it is possible to improve the elastic modulus without deteriorating the bending strength of the resin while obtaining the desired excellent communication characteristics.

Further, when a mixture is adjusted so that the content of the resin is 21 mass % or more, this is preferable because the bending strength of the magnetic compound can be kept high.

### 1-2. Coating Substance

The coating substance of this embodiment is formed on the surface of the metal magnetic powder by a surface treatment step described later. Presumably, the coating substance is considered to be attached to at least a part of or the whole part of the surface of the metal magnetic powder to form a metal magnetic powder composite. The coating substance is composed of at least one of a dicarboxylic acid or an anhydride produced by a dehydrating action in the molecule thereof and a derivative thereof.

The “derivative” as used herein refers to a compound which has been modified to such an extent that it does not significantly change the structure or properties of a parent body, such as introduction of functional groups, oxidation, reduction, substitution of atoms, wherein the “substitution of atoms” includes substances whose ends are replaced with alkali metals and made soluble.

As a result of examination by inventors of the present invention, it is found that among the dicarboxylic acids, dicarboxylic acids having a molecular weight of 500 or less (which is not large) are preferable as compared with polymers having a molecular weight of tens of thousands like resins. Further, among the dicarboxylic acids and derivatives thereof, phthalic acid, phthalic anhydride, maleic acid, maleic anhydride, derivatives of phthalic acid or maleic acid, derivatives of phthalic anhydride or maleic anhydride are preferable, and further preferably, a structure having 4 to 20 carbon atoms, with phthalic acid or maleic acid as a main skeleton, is more preferable. These dicarboxylic acids, dicarboxylic acid anhydrides or derivatives thereof do not necessarily have to be composed of only one type, and use of a plurality of them is acceptable. When the number of carbon atoms is within the above range, a bulk of the molecule becomes an appropriate size, so that it is easy to add the metal magnetic powder composite into the resin, which is suitable.

As an amount of the coating substance used for coating, it is preferable that a measured value of carbon obtained by a high-frequency combustion method, in the metal magnetic powder composite in which the surface of the metal magnetic powder is coated with the coating substance, is 0.1 mass % or more and 10 mass % or less. On the other hand, in the magnetic compound, there is a possibility that a coating agent is dispersed in the resin other than the coating substance remained on the surface of the particle, or compounded in the resin. Therefore, each desired property can be obtained by suitably setting the amount of the metal magnetic powder and the amount of resin, as the magnetic compound.

### 1-3. Resin

A very suitable resin of this embodiment is at least one of SPS (syndiotactic polystyrene) resin and m-PPE (modified polyphenylene ether) resin. At least one of SPS and m-PPE is adopted as the resin, so that kneading can be performed between the resin and the abovementioned metal magnetic powder composite, as will be described later in the item of the examples.

In a case of a low loss material such as a thermoplastic resin in which tan δε at 1 MHz is 0.05 or less as specified in IEC 60250 or JIS C 2138: 2007, the effect of this embodiment may be exerted even if the resin other than the abovementioned resin is used.

As the magnetic property in the high-frequency (2 GHz) region of the magnetic compound of the present invention (corresponding to the structure of the metal magnetic powder composite in the compound: 30 vol %), it is preferable that the real part μ′ of the composite relative magnetic permeability is 1.50 or more, and preferably 1.70 or more. Since the magnetic compound having such a property has a high magnetic permeability, it can exhibit a sufficient miniaturization effect, and is extremely useful for constructing an antenna with a small return loss.

Regarding the magnetic loss and the dielectric loss of the magnetic compound of the present invention, tan δμ and tan δε are preferably 0.10 or less, more preferably 0.05 or less, and still more preferably 0.02 or less, at measurement frequency of 2 GHz.

Further, regarding the real part μ′ of the magnetic permeability and the real part ε′ of the magnetic permeability of the magnetic compound according to the present invention, when a standard deviation when measured at 0.05 GHz intervals is 0.01 or less in a range of 0.75 GHz or more and 1.0 GHz or less, this is preferable because stable antenna property can be obtained when preparing an antenna used in the vicinity of 0.8 GHz.

### 2. Method for Manufacturing a Magnetic Compound

A method for manufacturing a magnetic compound will be described hereafter.

### 2-1. Preparing Step

In this step, various preparations for the magnetic compound are performed. For example, various raw materials such as the abovementioned metal magnetic powder, a source for the coating substance, and the resin which is a target to be mixed, are prepared.

### 2-2. Coating Step (Surface Treatment)

An organic compound (at least one of dicarboxylic acid, dicarboxylic acid anhydride and a derivative thereof) to be a coating substance is added to and mixed with the metal magnetic powder, to thereby obtain the metal magnetic powder composite. Among the dicarboxylic acids, dicarboxylic acids having a molecular weight of 500 or less (which is not large) are preferable as compared with polymers having a molecular weight of tens of thousands like resins. Further, among dicarboxylic acids, dicarboxylic anhydrides, and derivatives thereof, phthalic acid, phthalic anhydride, maleic acid, maleic anhydride, a derivative of phthalic acid or maleic acid, or a derivative of phthalic anhydride or maleic anhydride is preferable, and more preferably, a structure having 4 to 20 carbon atoms, with phthalic acid or maleic acid as a main skeleton, is preferable. These dicarboxylic acids, dicarboxylic acid anhydrides or derivatives thereof do not necessarily have to be composed of only one type, and use of a plurality of them is acceptable. When the amount of carbon is 0.1 mass % or more, dispersion in a resin can be suitably performed, which is preferable. In contrast, when the amount of carbon is 10 mass % or less, nonmagnetic components are not excessive, and the magnetic permeability when it is made into a compound can be secured, which is preferable.

An addition amount of the abovementioned organic compound is 2 to 15, more preferably 2.5 to 10, and still more preferably 5 to 10, with respect to the metal magnetic powder 100 by mass ratio.

When the addition amount is 2 or more, the metal magnetic powder and the resin are compatible with each other, and therefore property stability of the product at the time of production is improved. When the addition amount is 15 or less, the nonmagnetic component in the metal magnetic powder becomes an appropriate amount, and it is possible to suppress deterioration of the magnetic property of the metal magnetic powder composite itself composed of the metal magnetic powder coated with the coating substance. As a result, the high-frequency property can be kept relatively high when the metal magnetic powder composite is mixed in the resin to make a magnetic compound, and the property of the finally formed antenna can be kept relatively high as well.

Details of the mechanism for improving the “wettability” between the metal magnetic powder composite and the resin by the coating substance is not known, and therefore although it is only inferring, the carboxyl group side is attracted to the surface of the metal magnetic powder, and meanwhile the opposite side (the side without the carboxyl group) becomes compatible with the hydrophobic resin side, in view of the structural formula of the organic compound, and as a result, it can be considered that the metal magnetic powder composite becomes compatible with the resin satisfactorily. Further, as another explanation, the metal magnetic powder and a predetermined organic compound are mixed and a part of the metal magnetic powder is coated with the coating substance. However, it can be considered that by leaving the organic compound in a free state “not used for coating” in the metal magnetic powder composite without being removed, and allowing the organic compound to remain as it is, thereby forming a composite of the metal magnetic powder and the organic compound, some dispersing action is also generated in addition to the abovementioned “wettability” effect.

As a solvent to be added at the time of the surface treatment (a liquid to be added for improving compatibility between the metal magnetic powder and the coating substance), the abovementioned organic compound is not necessarily required to be completely soluble. It is preferable to adopt a method of adding a metal magnetic powder to the abovementioned mixture of the organic compound and the solvent to thereby impregnate the metal magnetic powder into the solvent, and thereafter removing the solvent.

It is also acceptable to adopt a method of adding the metal magnetic powder to a solution of the abovementioned coating substance, and stirring the mixture with a stirrer for both rotation and revolution, or stirring the mixture while applying a shearing force to form a paste. By passing through the step of pasting, the abovementioned coating substance and the metal magnetic powder are mixed so as to be compatible with each other satisfactorily. Therefore, the coating substance is easily adsorbed on the surface of the metal magnetic powder, and eventually the metal magnetic powder composite is easily formed. There is no problem as long as the coating substance is uniformly spread over the metal magnetic powder. Further, a mixer or the like may be used for removing and drying the solvent while kneading. After removing and drying the coating substance, it is essential to make the coating substance remain on a particle surface of the metal magnetic powder.

Further, it is necessary to form the metal magnetic powder composite while efficiently making contact between the metal magnetic powder and the abovementioned coating substance, and therefore a dispersion and kneader having a high shearing force may be used, or the metal magnetic powder may be dispersed in the solvent while applying a strong shearing force to the solvent.

As a dispersing machine having a strong shearing force which is used when adopting a method of preparing a paste and thereafter drying it in a powder state, T. K. Homomixer (registered trademark) manufactured by PRIMIX Corporation and Ultra-Turrax (registered trademark) manufactured by IKA Corporation, can be mentioned for example as turbine-stator type stirrers, and T.K. Mycolloider (registered trademark), T. K. Homomic line mill (registered trademark) and T.K. High line mill (registered trademark), etc., manufactured by PRIMIX Corporation can be mentioned for example as colloid mills, and a static mixer (registered trademark), a high pressure microreactor (registered trademark), and a high pressure homogenizer (registered trademark), etc., manufactured by NORITAKE COMPANY LIMITED, can be mentioned for example.

The strong/weak shearing force can be evaluated by a blade circumferential speed of a stirring blade as long as it is a device having the stirring blade. In this embodiment, a “strong shearing force” refers to one with a blade circumferential speed of 3.0 (m/s) or more, and preferably 5.0 (m/s) or more. When the blade circumferential speed is not less than the above value, the shearing force is moderately high, the pasting time can be shortened, and a production efficiency is reasonably good. However, in consideration of reducing a damage to the metal magnetic powder, it is also possible to reduce the damage by adjusting the blade circumferential speed to be low.

The blade circumferential speed can be calculated by the following formula: Circular constant×diameter (m) of turbine blade×stirring rotation number per rotation (rotation number). For example, when the diameter of the turbine blade is 3.0 cm (0.03 m) and the stirring rotation number is 8000 rpm, the rotation number per second is 133.3 (rps), and the blade circumferential speed is 12.57 (m/s).

It is preferable to remove the solvent by drying the obtained pasty product. At this time, the pasty product is set in a spread state on a vat so as to be dried at a temperature equal to or higher than a drying temperature of the solvent and lower than a decomposition temperature of the coating substance. When a coating treatment is applied to, for example, a substance which is easily oxidized, the solvent can be dried in an inert atmosphere, and can be dried in nitrogen atmosphere in terms of a cost.

Here, when a surface treatment is performed using an organic compound which can be strongly applied on the metal magnetic powder, for example, it is acceptable to employ a technique of performing filtration to remove a certain amount of solvent in advance, and thereafter performing drying. Thereby, the content of the solvent can be reduced in advance, thus making it possible to shorten a drying time. Whether or not the coating is strong or not, can be evaluated, for example, by evaporating a filtrate and determining the extent of residual components.

On the other hand, when adopting a method of adding the metal magnetic powder after mixing the organic compound that can be adhered to the solvent and applying surface treatment thereto while stirring and mixing, FM mixer manufactured by Nippon Coke Co., Ltd., and Super Mixer manufactured by Kawata Co., Ltd. can be used. Further, when using such a device attached with a heating device for evaporating the solvent, there is no necessity for taking out the powder after treatment and making the powder subject to drying, which is preferable.

When performing such a treatment, for the purpose of suppressing deterioration of properties due to oxidation of the metal magnetic powder, it is preferable to perform the treatment in the inert atmosphere. Further, it is more preferable to perform an operation of aerating the inert gas (nitrogen in terms of cost) to a liquid in which the solvent and the organic compound are mixed once. An interior of the processing vessel is replaced with the inert gas, and thereafter the metal magnetic powder is added so as not to be oxidized, and the solvent, the organic compound and the metal magnetic powder are mixed to prepare a mixture, and thereafter by setting the heating temperature to the drying temperature of the solvent or more and less than the decomposition temperature of the coating substance, the mixture can be dried. In order to dry the mixture in a shorter time, it is preferable to perform drying by operating a mixer and rolling the mixture in the mixer.

In the thus obtained aggregate of the metal magnetic powder composite with the coating substance formed on the surface, it is preferable to remove coarse particles using a classifier or a sieve. When excessively large coarse particles are present, a force is applied to a certain portion of the coarse particles when preparing the antenna, thus involving a problem that the mechanical property is deteriorated. When classifying is performed using the sieve, it is appropriate to use a mesh with an opening of 500 mesh or less.

The properties and the composition of the metal magnetic powder composite obtained through the above steps are confirmed by the following method.

### (BET Specific Surface Area)

BET specific surface area is obtained by BET one-point method using 4 SOURVE US manufactured by Yuasa Ionics Co., Ltd.

### (Evaluation of Magnetic Properties of Metal Magnetic Powder Composite)

Coercive force He (Oe or kA/m), saturation magnetization as (Am²/kg) and squareness ratio SQ in an external magnetic field of 10 kOe (795.8 kA/m), can be measured as magnetic properties (bulk properties) of the obtained metal magnetic powder composite (or metal magnetic powder), by using VSM device (VSM-7P) manufactured by Toei Industry Co., Ltd. Δσs is a percentage (%) of decrease of saturation magnetization when the magnetic powder is allowed to stand in a hot and humid environment of 60° C. and 90% for one week.

### (Measurement of TAP Density)

TAP density can be measured by a method described in JP-A-2007-263860. TAP density can also be measured by a technique of JISK-5101:1991.

2-4. Kneading Step with Resin

The obtained metal magnetic powder composite and the abovementioned resin are kneaded to form a magnetic compound. In the kneading step, a metal magnetic powder dispersed state is made in which the metal magnetic powder is mixed in the resin. In a state after kneading, it is desirable that the metal magnetic powder is dispersed uniformly in the resin. When an amount of metal magnetic powder composite that can be mixed in the resin is large, the magnetic permeability at the time of adding high-frequency becomes particularly high, thereby deteriorating the mechanical property of the resin as a result. Therefore, it is necessary to consider the addition amount of the metal magnetic powder composite in consideration of a balance between the mechanical property and high-frequency property.

Means for preparing the magnetic compound is not particularly limited. For example, kneading strength or the like may be adjusted by using a commercially available kneading machine.

A method of preparing the magnetic compound by heating a mixture containing the resin, the metal magnetic powder, and the abovementioned organic compound may be adopted, or a method of adding the metal magnetic powder composite to a melted resin may be adopted.

Melting of the resin is usually performed at a higher melting temperature than a melting point of the resin, and when decomposability of the resin is high, the melting temperature of the resin is set to the decomposition temperature or lower.

Further, in order to improve the mechanical strength, etc., of the resin, fibrous glass fiber, carbon fiber, graphite fiber, aramid fiber, vinylon fiber, polyamide fiber, polyester fiber, hemp fiber, kenaf fiber, bamboo fiber, steel fiber, cotton, rayon, aluminum fiber, carbon nanofiber, a carbon nanotube, a cotton fibril, a silicon nitride whisker, an alumina whisker, a silicon carbide whisker, a nickel whisker, a plate-like talc, a kaolin clay, a mica, a glass flake, an aragonite, a calcium sulfate, an aluminum hydroxide, an organized montmorillonite, a swellable synthetic Mica, graphite, particulate calcium carbonate, silica, glass beads, titanium oxide, zinc oxide, wollastonite, vermiculite, shirasu balloon, glass balloon, nano titanium oxide, nanosilica, carbon black, etc., which are known as commonly known additives can be added. Other than these additives, a time-dependent deterioration suppressing substance may be added within a range that does not deteriorate the properties of the antenna due to addition.

### (Property Evaluation of the Magnetic Compound)

0.2 g of the magnetic compound obtained by the abovementioned method was placed in a donut-shaped container, and a hand press machine or a hot press machine is used, to thereby form a molded body of a toroidal shaped magnetic compound having an outer diameter of 7 mm and an inner diameter of 3 mm. Thereafter, A network analyzer (E8362C) manufactured by Agilent Technologies Co., Ltd. and coaxial type S parameter method sample holder kit manufactured by Kanto Electronic Applied Development Co., Ltd. (product model number: CSH 2-APC 7, sample size: φ7.0 mm−φ3.04 mm×5 mm) were used, to thereby confirm the high-frequency property by measuring the real part (μ′) of the magnetic permeability, the imaginary part (μ″) of the magnetic permeability, the real part (ε′) of permittivity, and the imaginary part (ε″) of permittivity, at measurement intervals of 0.05 GHz in a high-frequency region of 0.5 to 5 GHz of the molded body of the obtained magnetic compound. Wherein calculation is performed, satisfying tan δ ε=ε″/ε″ and tan δ μ=μ′/μ″.

According to this embodiment, it is possible to provide the magnetic compound excellent in the high-frequency property and excellent in the mechanical strength, using at least one of syndiotactic polystyrene (SPS) resin and modified polyphenylene ether (m-PPE) resin.

### 3. MODIFIED EXAMPLE ETC.

The technical scope of the present invention is not limited to the abovementioned embodiment, and includes various modifications and improvements within the scope of deriving the specific effects obtained by the constituent features of the invention and combinations thereof.

### (Metal Magnetic Particles, Coating Substance and Resin)

In this embodiment, main metal elements and compounds have been described in detail for the metal magnetic particles, the coating substance and the resin. On the other hand, the metal magnetic particles, the coating substance, and the resin may also contain elements other than the above-listed elements.

### (Application)

The magnetic compound of this embodiment can be used for an antenna, an inductor, and a radio wave shielding material. In particular, even in the antenna composed of the magnetic compound, and also in an electronic communication device (electronic device) including such an antenna, relatively high communication property as indicated in the items of the embodiments described later, can be obtained. In other words, the magnetic compound of this embodiment can be processed into electronic parts, antennas, electronic devices and the like as described above, and for example, the magnetic compound can be an antenna material.

For example, an electronic communication device having a portion that functions as the electronic communication device based on radio waves received by the antenna of this embodiment, and a controller for controlling this portion based on the received radio waves, can be mentioned as the abovementioned electronic communication device.

As the electronic communication device of this embodiment, a communication device having a communication function is preferable in view of having an antenna. However, as long as it is the electronic device which receives radio waves by the antenna and exercises its function, there is no problem in using an electronic device that does not have a communication function such as a telephone call.

### EXAMPLES

Next, the present invention will be described in detail by showing examples. It is a matter of course that the present invention is not limited to the following examples.

Various conditions in each example listed in this item are described in the following tables.

Table 1 describes various conditions for examples 1 to 6, high-frequency property at 750 MHz to 1 GHz, and high-frequency property at 2 GHz.

Table 2 describes high-frequency property at 800 MHz, 1.5 GHz, 2.5 GHz, and 3 GHz for examples 1 to 6.

TABLE 1

| | | | Metal | | | | | | | | | |
|---|---|---|---|---|---|---|---|---|---|---|---|---|
| | | | magnetic | | | | | | | | | |
| | | | powder | | Metal magnetic powder property | | | | | | | |
| | Surface | | composite | Resin | Hc | Hc | σs | SQ | SFD | Δσs | BET | TAP |
| | treatment | Resin | (vol %) | (mass %) | (Oe) | (kA/m) | (Am²/kg) | (—) | (—) | (%) | (m²/g) | (g/cc) |
| Example 1 | Phthalic acid | SPS | 20 | 50.3% | 724 | 57.6 | 173.5 | 0.322 | 3.268 | 5.7 | 34.9 | 1.373 |
| Example 2 | Phthalic acid | SPS | 30 | 37.1% | 724 | 57.6 | 173.5 | 0.322 | 3.268 | 5.7 | 34.9 | 1.373 |
| Example 3 | Phthalic acid | SPS | 40 | 27.5% | 724 | 57.6 | 173.5 | 0.322 | 3.268 | 5.7 | 34.9 | 1.373 |
| Example 4 | Phthalic acid | m-PPE | 30 | 30.7% | 724 | 57.6 | 173.5 | 0.322 | 3.268 | 5.7 | 34.9 | 1.373 |
| Example 5 | Maleic acid | SPS | 30 | 27.5% | 696 | 55.4 | 172.2 | 0.310 | 3.409 | 9.7 | 31.1 | 1.537 |
| Example 6 | Maleic acid | m-PPE | 30 | 30.7% | 696 | 55.4 | 172.2 | 0.310 | 3.409 | 9.7 | 31.1 | 1.537 |

| | | | | Compound relative magnetic permeability · | | | | | | | | | |
|---|---|---|---|---|---|---|---|---|---|---|---|---|---|
| | Compound strength | | | relative permittivity (750 MHz~1 GHz) | | | | | | | | | |
| | Bending | Elastic | | μ′ | | ε′ | | Compound relative magnetic permeability · | | | | | |
| | strength | modulus | | | Standard | | Standard | relative (2 GHz) | | | | | |
| | (MPa) | (MPa) | Kneading | Average | deviation | Average | deviation | μ′ | μ″ | tanδμ | ε′ | ε″ | tanδε |
| Example 1 | 43.3 | 3400 | ◯ | 1.436 | 0.001 | 3.983 | 0.001 | 1.459 | 0.033 | 0.022 | 3.989 | 0.031 | 0.008 |
| Example 2 | 38.6 | 3952 | ◯ | 1.676 | 0.003 | 5.291 | 0.001 | 1.718 | 0.052 | 0.030 | 5.293 | 0.055 | 0.010 |
| Example 3 | 35.0 | 5642 | ◯ | 1.836 | 0.003 | 5.877 | 0.001 | 1.888 | 0.072 | 0.038 | 5.883 | 0.055 | 0.009 |
| Example 4 | 37.4 | 4055 | ◯ | 1.730 | 0.003 | 5.364 | 0.004 | 1.776 | 0.052 | 0.029 | 5.364 | 0.052 | 0.010 |
| Example 5 | 49.4 | 3574 | ◯ | 1.712 | 0.003 | 4.941 | 0.004 | 1.755 | 0.066 | 0.038 | 4.945 | 0.058 | 0.012 |
| Example 6 | 48.4 | 3932 | ◯ | 1.699 | 0.002 | 5.416 | 0.005 | 1.742 | 0.052 | 0.030 | 5.417 | 0.065 | 0.012 |

TABLE 2

| | | | Metal | | | | | | | | | | | | |
|---|---|---|---|---|---|---|---|---|---|---|---|---|---|---|---|
| | | | magnetic | | | | | | | | | | | | |
| | | | powder | Compound relative magnetic permeability · | | | | | | Compound relative magnetic permeability · | | | | | |
| | Surface | | composite | relative permittivity (800 MHz) | | | | | | relative permittivity (1.5 GHz) | | | | | |
| | treatment | Resin | (vol %) | μ′ | μ″ | tanδμ | ε′ | ε″ | tanδε | μ′ | μ″ | tanδμ | ε′ | ε″ | tanδε |
| Example 1 | Phthalic acid | SPS | 20 | 1.776 | 0.015 | 0.008 | 6.377 | 0.063 | 0.010 | 1.802 | 0.035 | 0.020 | 6.365 | 0.079 | 0.012 |
| Example 2 | Phthalic acid | SPS | 30 | 1.745 | 0.011 | 0.006 | 6.106 | 0.029 | 0.005 | 1.771 | 0.031 | 0.017 | 6.108 | 0.043 | 0.007 |
| Example 3 | Phthalic acid | SPS | 40 | 1.850 | 0.018 | 0.010 | 6.700 | 0.126 | 0.019 | 1.886 | 0.045 | 0.024 | 6.670 | 0.129 | 0.019 |
| Example 4 | Phthalic acid | m-PPE | 30 | 1.823 | 0.017 | 0.010 | 6.724 | 0.171 | 0.025 | 1.854 | 0.042 | 0.023 | 6.675 | 0.173 | 0.026 |
| Example 5 | Maleic acid | SPS | 30 | 1.713 | 0.019 | 0.011 | 4.938 | 0.019 | 0.004 | 1.732 | 0.034 | 0.019 | 4.950 | 0.036 | 0.007 |
| Example 6 | Maleic acid | m-PPE | 30 | 1.696 | 0.017 | 0.010 | 5.415 | 0.025 | 0.005 | 1.720 | 0.026 | 0.015 | 5.423 | 0.042 | 0.008 |

| | Compound relative magnetic permeability · | | | | | | Compound relative magnetic permeability · | | | | | |
|---|---|---|---|---|---|---|---|---|---|---|---|---|
| | relative permittivity (2.5 GHz) | | | | | | relative permittivity (3 GHz) | | | | | |
| | μ′ | μ″ | tanδμ | ε′ | ε″ | tanδε | μ′ | μ″ | tanδμ | ε′ | ε″ | tanδε |
| Example 1 | 1.843 | 0.107 | 0.058 | 6.344 | 0.123 | 0.019 | 1.849 | 0.150 | 0.081 | 6.319 | 0.145 | 0.023 |
| Example 2 | 1.810 | 0.098 | 0.054 | 6.098 | 0.088 | 0.014 | 1.816 | 0.136 | 0.075 | 6.076 | 0.110 | 0.018 |
| Example 3 | 1.927 | 0.139 | 0.072 | 6.634 | 0.172 | 0.026 | 1.932 | 0.190 | 0.098 | 6.603 | 0.193 | 0.029 |
| Example 4 | 1.895 | 0.125 | 0.066 | 6.625 | 0.212 | 0.032 | 1.902 | 0.172 | 0.090 | 6.590 | 0.233 | 0.035 |
| Example 5 | 1.768 | 0.109 | 0.062 | 4.940 | 0.075 | 0.015 | 1.770 | 0.151 | 0.085 | 4.920 | 0.088 | 0.018 |
| Example 6 | 1.754 | 0.089 | 0.051 | 5.415 | 0.085 | 0.016 | 1.764 | 0.129 | 0.073 | 5.389 | 0.103 | 0.019 |

In contrast, table 3 describes various conditions for comparative examples 1 to 4, high-frequency property at 750 MHz to 1 GHz and high-frequency property at 2 GHz.

Table 4 describes high-frequency property at 800 MHz, 1.5 GHz, 2.5 GHz, and 3 GHz for comparative examples 1 to 4.

Table 5 also shows various conditions for comparative examples 5 to 7, high-frequency property at 750 MHz to 1 GHz, and high-frequency property at 2 GHz.

Table 6 describes high-frequency property at 800 MHz, 1.5 GHz, 2.5 GHz, and 3 GHz for comparative examples 5 to 7.

TABLE 3

| | | | Metal | | | | | | | | | |
|---|---|---|---|---|---|---|---|---|---|---|---|---|
| | | | magnetic | | | | | | | | | |
| | | | powder | | Metal magnetic powder property | | | | | | | |
| | Surface | | composite | Resin | Hc | Hc | σs | SQ | SFD | Δσs | BET | TAP |
| | treatment | Resin | (vol %) | (mass %) | (Oe) | (kA/m) | (Am²/kg) | (—) | (—) | (%) | (m²/g) | (g/cc) |
| Comparative | — | Epoxi | 30 | 27.4% | 757 | 60.2 | 179.3 | 0.337 | 3.141 | 7.6 | 37.3 | 1.093 |
| example 1 | | | | | | | | | | | | |
| Comparative | Phthalic | Epoxi | 30 | 27.4% | 724 | 57.6 | 173.5 | 0.322 | 3.268 | 5.7 | 34.9 | 1.373 |
| example 2 | acid | | | | | | | | | | | |
| Comparative | — | SPS | 0 | 100% | — | — | — | — | — | — | — | — |
| example 3 | | | | | | | | | | | | |
| Comparative | — | m-PPE | 0 | 100% | — | — | — | — | — | — | — | — |
| example 4 | | | | | | | | | | | | |

| | | | | Compound relative magnetic permeability · | | | | | | | | | |
|---|---|---|---|---|---|---|---|---|---|---|---|---|---|
| | Compound strength | | | relative permittivity (750 MHz~1 GHz) | | | | | | | | | |
| | Bending | Elastic | | μ′ | | ε′ | | Compound relative magnetic permeability · | | | | | |
| | strength | modulus | | | Standard | | Standard | relative permittivity (2 GHz) | | | | | |
| | (MPa) | (MPa) | Kneading | Average | deviation | Average | deviation | μ′ | μ″ | tanδμ | ε′ | ε″ | tanδε |
| Comparative | — | — | — | 1.859 | 0.005 | 6.710 | 0.039 | 1.916 | 0.113 | 0.059 | 6.466 | 0.470 | 0.073 |
| example 1 | | | | | | | | | | | | | |
| Comparative | — | — | — | 1.921 | 0.005 | 7.848 | 0.057 | 1.980 | 0.120 | 0.060 | 7.494 | 0.664 | 0.089 |
| example 2 | | | | | | | | | | | | | |
| Comparative | 65.1 | 1991 | ◯ | 1.013 | 0.001 | 2.299 | 0.001 | 1.007 | 0.001 | 0.001 | 2.306 | 0.011 | 0.005 |
| example 3 | | | | | | | | | | | | | |
| Comparative | 64.1 | 1905 | ◯ | 1.015 | 0.017 | 2.356 | 0.001 | 1.009 | 0.002 | 0.002 | 2.360 | 0.015 | 0.006 |
| example 4 | | | | | | | | | | | | | |

TABLE 4

| | | | Metal | | | | | | | | | | | | |
|---|---|---|---|---|---|---|---|---|---|---|---|---|---|---|---|
| | | | magnetic | | | | | | | | | | | | |
| | | | powder | Compound relative magnetic permeability · | | | | | | Compound relative magnetc permeability · | | | | | |
| | Surface | | composite | relative permittivity (800 MHz) | | | | | | relative permittivity (1.5 GHz) | | | | | |
| | treatment | Resin | (vol %) | μ′ | μ″ | tanδμ | ε′ | ε″ | tanδε | μ′ | μ″ | tanδμ | ε′ | ε″ | tanδε |
| Comparative | — | Epoxi | 30 | 1.858 | 0.052 | 0.028 | 6.726 | 0.470 | 0.070 | 1.896 | 0.070 | 0.037 | 6.542 | 0.461 | 0.070 |
| example 1 | | | | | | | | | | | | | | | |
| Comparative | Phthalic | Epoxi | 30 | 1.920 | 0.044 | 0.023 | 7.872 | 0.688 | 0.087 | 1.958 | 0.073 | 0.037 | 7.604 | 0.660 | 0.087 |
| example 2 | acid | | | | | | | | | | | | | | |
| Comparative | — | SPS | 0 | 1.014 | 0.016 | 0.016 | 2.299 | −0.008 | −0.003 | 1.010 | 0.008 | 0.008 | 2.302 | −0.001 | 0.000 |
| example 3 | | | | | | | | | | | | | | | |
| Comparative | — | m-PPE | 0 | 1.016 | 0.017 | 0.016 | 2.356 | −0.002 | −0.001 | 1.011 | 0.010 | 0.010 | 2.358 | 0.004 | 0.002 |
| example 4 | | | | | | | | | | | | | | | |

| | Compound relative magnetic permeability · | | | | | | Compound relative magnetic permeability · | | | | | |
|---|---|---|---|---|---|---|---|---|---|---|---|---|
| | relative permittivity (2.5 GHz) | | | | | | relative permittivity (3 GHz) | | | | | |
| | μ′ | μ″ | tanδμ | ε′ | ε″ | tanδε | μ′ | μ″ | tanδμ | ε′ | ε″ | tanδε |
| Comparative | 1.922 | 0.163 | 0.085 | 6.399 | 0.485 | 0.076 | 1.919 | 0.212 | 0.111 | 6.333 | 0.496 | 0.078 |
| example 1 | | | | | | | | | | | | |
| Comparative | 1.987 | 0.178 | 0.090 | 7.399 | 0.673 | 0.091 | 1.978 | 0.241 | 0.122 | 7.312 | 0.682 | 0.093 |
| example 2 | | | | | | | | | | | | |
| Comparative | 1.007 | −0.005 | −0.005 | 2.304 | 0.020 | 0.009 | 1.013 | −0.012 | −0.012 | 2.295 | 0.032 | 0.014 |
| example 3 | | | | | | | | | | | | |
| Comparative | 1.008 | −0.004 | −0.004 | 2.359 | 0.025 | 0.011 | 1.015 | −0.010 | −0.010 | 2.348 | 0.035 | 0.015 |
| example 4 | | | | | | | | | | | | |

TABLE 5

| | | | Metal | | | | | | | | | |
|---|---|---|---|---|---|---|---|---|---|---|---|---|
| | | | magnetic | | | | | | | | | |
| | | | powder | | Metal magnetic powder property | | | | | | | |
| | Surface | | composite | Resin | Hc | Hc | σs | SQ | SFD | Δσs | BET | TAP |
| | treatment | Resin | (VOL %) | (mass %) | (Oe) | (kA/m) | (Am²/kg) | (—) | (—) | (%) | (m²/g) | (g/cc) |
| Com* | — | SPS | 30 | 37.1% | 757 | 60.2 | 179.3 | 0.337 | 3.141 | 7.6 | 37.3 | 1.093 |
| example5 | | | | | | | | | | | | |
| Com* | — | m-PPE | 30 | 30.7% | 757 | 60.2 | 179.3 | 0.337 | 3.141 | 7.6 | 37.3 | 1.093 |
| example6 | | | | | | | | | | | | |
| Com* | — | PPS + | 30 | 36 + | 757 | 60.2 | 179.3 | 0.337 | 3.141 | 7.6 | 37.3 | 1.093 |
| example7 | | PA6T | | 3% | | | | | | | | |

| | | | | Compound relative magnetic permeability · | | | | | | | | | |
|---|---|---|---|---|---|---|---|---|---|---|---|---|---|
| | Compound strength | | | relative permittivity (750 MHz~1 GHz) | | | | | | | | | |
| | Bending | Elastic | | μ′ | | ε′ | | Compound relative magnetic permeability · | | | | | |
| | strength | modulus | | | Standard | | Standard | relative permittivity (2 GHz) | | | | | |
| | (MPa) | (MPa) | Kneading | Average | deviation | Average | deviation | μ′ | μ″ | tanδμ | ε′ | ε″ | tanδε |
| Com* | — | — | X | — | — | — | — | — | — | — | — | — | — |
| example5 | | | (Lgnition) | | | | | | | | | | |
| Com* | — | — | X | — | — | — | — | — | — | — | — | — | — |
| example6 | | | (Lgnition) | | | | | | | | | | |
| Com* | — | — | X | — | — | — | — | — | — | — | — | — | — |
| example7 | | | (Lgnition) | | | | | | | | | | |

Com* . . . Comparative

TABLE 6

| | | | Metal | | | | | | | | | | | | |
|---|---|---|---|---|---|---|---|---|---|---|---|---|---|---|---|
| | | | magnetic | Compound relative magnetic permeability · | | | | | | Compound relative magnetic permeability · | | | | | |
| | Surface | | powder | relative permittivity (800 MHz) | | | | | | relative permittivity (1.5 GHz) | | | | | |
| | treatment | Resin | (vol %) | μ′ | μ″ | tanδμ | ε′ | ε″ | tanδε | μ′ | μ″ | tanδμ | ε′ | ε″ | tanδε |
| Com* | — | SPS | 30 | — | — | — | — | — | — | — | — | — | — | — | — |
| example 5 | | | | | | | | | | | | | | | |
| Com* | — | m-PPE | 30 | — | — | — | — | — | — | — | — | — | — | — | — |
| example 6 | | | | | | | | | | | | | | | |
| Com* | — | PPS + | 30 | — | — | — | — | — | — | — | — | — | — | — | — |
| example 7 | | PA6T | | | | | | | | | | | | | |

| | Compound relative magnetic permeability · | | | | | | Compound relative magnetic permeability · | | | | | |
|---|---|---|---|---|---|---|---|---|---|---|---|---|
| | relative permittivity (2.5 GHz) | | | | | | relative permittivity (3 GHz) | | | | | |
| | μ′ | μ″ | tanδμ | ε′ | ε″ | tanδε | μ′ | μ″ | tanδμ | ε′ | ε″ | tanδε |
| Com* | — | — | — | — | — | — | — | — | — | — | — | — |
| example 5 | | | | | | | | | | | | |
| Com* | — | — | — | — | — | — | — | — | — | — | — | — |
| example 6 | | | | | | | | | | | | |
| Com* | — | — | — | — | — | — | — | — | — | — | — | — |
| example 7 | | | | | | | | | | | | |

Com* . . . Comparative

The blanks in each table are items that have not been measured or can not be measured. Each example will be described below.

### Example 1

First, ethanol (special grade reagent manufactured by Wako Pure Chemical Industries, Ltd.) as a solvent was added to 25 g of phthalic acid (special grade reagent manufactured by Wako Pure Chemical Industries, Ltd.) so as to be 500 g, and phthalic acid was dissolved in ethanol. To this solution, a metal magnetic powder 500 g (iron-cobalt metal particle, major axis length: 40 nm, BET: 37.3 m²/g, σs: 179.3 Am²/kg, carbon content (high-frequency combustion method): 0.01 mass %) was added under an inert atmosphere, thereby precipitating the metal magnetic powder in the solution. Then, mixing was carried out by stirring in the air at 8000 rpm for 2 minutes using a high-speed stirrer (TK Homomixer Mark II, manufactured by PRIMIX Corporation), thereby forming a paste state of the metal magnetic powder.

The obtained paste was spread on an aluminum vat, heated for 1 hour at near an evaporation temperature of ethanol (78° C.) for 1 hour, then the temperature was raised to 120° C. and heating was performed for 1.5 hours, and ethanol was removed from the paste to obtain an aggregate in which phthalic acid and metal magnetic powder were mixed together. Thereby, a part or more of the surface of the metal magnetic powder was coated with phthalic acid. The obtained aggregate was passed through a 500 mesh sieve so that coarse particles were removed, to thereby obtain the metal magnetic powder composite of this example. The obtained metal magnetic powder composite had properties of BET: 34.9 m²/g, σs: 173.5 Am²/kg, and carbon content (high-frequency combustion method): 2.82 mass %. When true density of the obtained metal magnetic powder composite was obtained by a gas phase (He gas) substitution method, it was 5.58 g/cm³. The value of the obtained true density was used for calculation of a compounding ratio for setting the content of the metal magnetic powder composite in the compound to a desired ratio.

During formation of the molded body, a metal magnetic powder composite having a volume filling rate of 20 vol %, and 11.5 g of XAREC (registered trademark) SP 105 (SPS/syndiotactic polystyrene manufactured by Idemitsu Kosan Co., Ltd.) only having a specific gravity of 1.18 g/cm³, were weighed in nitrogen atmosphere, and placed in No. 5 standard bottle and covered with a lid. After lightly shaking with hands and stirring, kneading was performed for 10 minutes (including a charging time of resin and magnetic powder) in the nitrogen atmosphere at a set temperature of 300° C. and at a kneading stirring speed of 100 rpm using a small kneader (DSM Xplore (registered trademark) MC 15 manufactured by Xplore Instruments), to thereby prepare a kneaded matter, namely, the magnetic compound.

The obtained magnetic compound was charged into an injection molding machine as an optional device of the small kneader under the conditions of a cylinder temperature of 300° C. and a mold temperature of 130° C., to thereby prepare a molded body for a bending test (ISO 178 standard size: 80 mm×10 mm×4 mm), and thereafter an elastic modulus (MPa) was measured after measuring the bending strength and calculating a bending displacement, with a distance between fulcrums set to 16 mm, using a digital force gauge (ZTS-500N manufactured by Imada Corporation).

Further, in order to measure the high-frequency property, 0.2 g of the magnetic compound was charged into a donut-shaped jig having a diameter of 6 mm and then heated at 300° C. for 20 minutes using a small hot press machine (manufactured by AS ONE Corporation). Thus, the resin was melted in the magnetic compound, it was molded into a toroidal shaped molded body having an outer diameter of 7 mm and an inner diameter of 3 mm and cooled while pressurizing, and thereafter the high-frequency property was measured for the obtained molded body by a method described in the abovementioned embodiment.

### Example 2

This example was performed in the same way as example 1, other than a point that the addition amount of the metal magnetic powder composite was changed to an amount corresponding to 30 vol %, and the addition amount of SPS was adjusted accordingly.

### Example 3

This example was performed in the same way as example 1, other than a point that the addition amount of the metal magnetic powder composite was changed to an amount corresponding to 40 vol %, and the addition amount of SPS was adjusted accordingly.

### Example 4

This example was performed in the same way as example 2, other than a point that the resin to be used was changed to ZYLON (registered trademark) AH-40 (m-PPE/modified polyphenylene ether manufactured by Asahi Kasei Chemicals Corporation) having a specific gravity of 1.06 g/cm³.

### Example 5

The metal magnetic powder was sieved using a 500 mesh sieve, and 5% (2.5 g) of maleic acid with respect to the magnetic powder and 30 wt % (15 g) of ethanol as the solvent with respect to the magnetic powder were added to the metal magnetic powder (50 g) under the sieve, and they were mixed in an agate mortar for 5 minutes. Drying was performed at 60° C. for 2 hours, to thereby obtain a powder.

11.5 g of XAREC (registered trademark) SP 105 (SPS/syndiotactic polystyrene manufactured by Idemitsu Kosan Co., Ltd.,) only having a specific gravity of 1.18 g/cm³ was weighed in nitrogen and placed in No. 5 standard bottle and covered with a lid. After lightly shaking with hands and stirring, kneading was performed for 10 minutes (including a charging time of resin and magnetic powder) in the nitrogen atmosphere at a set temperature of 300° C. and at a kneading stirring speed of 100 rpm using a small kneader (DSM Xplore (registered trademark) MC 15 manufactured by Xplore Instruments), to thereby prepare the kneaded matter, namely, the magnetic compound.

The compound thus obtained was charged into an injection molding machine as an optional device of the small kneader under the conditions of a cylinder temperature of 300° C. and a mold temperature of 130° C., to thereby prepare a molded body for bending test (ISO 178 standard size: 80 mm×10 mm×4 mm). The mechanical strength (bending property/elastic modulus) was measured for each of the obtained molded body.

Further, in order to measure the high-frequency property, 0.2 g of the kneaded matter was charged into the donut-shaped jig having a diameter of 6 mm and then heated at 300° C. for 20 minutes using a small hot press machine (manufactured by AS ONE Corporation), to thereby melt the resin, and thereafter cooled while pressurizing, to thereby obtain a toroidal shaped molded body having an outer diameter of 7 mm and an inner diameter of 3 mm.

### Example 6

This example was performed in the same way as example 5, other than a point that the resin to be used was changed to ZYLON (registered trademark) AH-40 (m-PPE/modified polyphenylene ether manufactured by Asahi Kasei Chemicals Corporation) having a specific gravity of 1.06 g/cm³.

### Comparative Example 1

In this example, a metal magnetic powder of example 1 not treated with phthalic acid was used. An epoxy resin (one-pack type epoxy resin manufactured by Tesque Co., Ltd.) was weighed so that the metal magnetic powder was 30 vol %, and the metal magnetic powder was dispersed in the epoxy resin using a vacuum stirring/defoaming mixer (V-mini 300) manufactured by EME Co., Ltd., to thereby form a paste. This paste was dried on a hot plate at 60° C. for 2 hours, to thereby obtain a composite of metal magnetic powder and resin. This composite was granulated to prepare a composite powder, and 0.2 g of this composite powder was placed in the donut-shaped container and subjected to a load of 1 t by a hand press machine, to thereby obtain a toroidal shaped molded body having an outer diameter of 7 mm and an inner diameter of 3 mm. The evaluation was made in the same way as in example 1.

### Comparative Example 2

This example was performed in the same way as comparative example 1, other than a point that the metal magnetic powder used in comparative example 1 was changed to the metal magnetic powder composite used in example 2.

### Comparative Example 3

This example was performed in the same way as example 2, other than a point that the metal magnetic powder composite was not added.

### Comparative Example 4

This example was performed in the same way as example 4, other than a point that the metal magnetic powder composite was not added.

### Comparative Example 5

This example was performed in the same way as example 2, other than a point that the metal magnetic powder was not surface-treated with phthalic acid.

In this example, at the time of preparing the kneaded matter, the metal magnetic powder was ignited and smoke was generated at a stage when the kneaded matter was taken out into the atmosphere, and the kneaded matter could not be prepared from the beginning.

### Comparative Example 6

This example was performed in the same way as example 4, other than a point that the metal magnetic powder was not surface-treated with phthalic acid.

In this example, at the time of preparing the kneaded matter, the metal magnetic powder was ignited and smoke was generated at a stage when the kneaded matter was taken out into the atmosphere, and the kneaded matter could not be prepared from the beginning.

### Comparative Example 7

In this example, a mixed resin of a thermoplastic resin and an aromatic nylon was used, which is an existing technique described in JP-A-2013-77802, and which is known as a technique of improving conformity between PPS resin excellent in mechanical property and having small loss of resin itself, and the surface of the magnetic powder. Thereby, whether the effect same as the effect of each example of the magnetic compound could be observed, was confirmed. Specifically, comparative example 7 was performed in the same way as example 1 other than a point that the metal magnetic powder was not surface treated with phthalic acid, and the resin in which DURAFIDE (registered trademark) (A0220A9 manufactured by PPS / polyphenylene sulfide resin Polyplastics Co., Ltd.) and aromatic nylon 6T BESTAMID (registered trademark) (HTplus M1000 manufactured by Daicel-Evonik KK) were mixed at a ratio of 9:1, was used.

In this example, during preparation of the kneaded matter, the metal magnetic powder was ignited and smoke was generated at the stage when the kneaded matter was taken out into the atmosphere, and the kneaded matter could not be prepared from the beginning.

### Result

The tables listed above indicate summarized contents described above.

When each table is referenced, it is found that any one of the examples shows excellent values including the real part (μ′) of magnetic permeability, the imaginary part (μ″) of magnetic permeability, the real part (ε′) of permittivity, the imaginary part (ε″) of permittivity, and further, including the standard deviation of μ′ and ε′ in the range of 750 MHz to 1 GHz, at all frequencies described in each table.

In contrast, in the comparative example, one of the real part (μ′) of magnetic permeability and the imaginary part (μ″) of magnetic permeability was inevitably inferior to that of the example. Further, in a sample mixed with the magnetic powder, burning occurred due to the ignition of the magnetic powder in a stage of manufacturing the compound except for a sample of the present invention, thus making it impossible to prepare the compound.

As a result thereof, according to the abovementioned example, it becomes clear that the magnetic compound excellent in high-frequency property and excellent in mechanical strength, and the related material thereof can be provided, using at least one of a syndiotactic polystyrene (SPS) resin and a modified polyphenylene ether (m-PPE) resin.

When the antenna is made of a material in which the metal magnetic powder is mixed into the resin, the antenna itself can be miniaturized by a wavelength shortening effect, thereby contributing to the miniaturization of portable devices and smartphones. In addition to the antenna, application to radio wave shielding materials, inductors and the like, is also possible.

1. A magnetic compound, comprising:
a metal magnetic powder; and
one or more resins selected from syndiotactic polystyrene (SPS) resin and modified polyphenylene ether (m-PPE) resin,
wherein the metal magnetic powder is coated with one or more coating substances selected from dicarboxylic acid, dicarboxylic acid anhydride and a derivative thereof so that a part or the whole part of a surface of the metal magnetic powder is coated, and
content of the resin is 21 mass % or more.

2. A magnetic compound, comprising:
a metal magnetic powder; and
a resin,
wherein the resin is one or more resins selected from syndiotactic polystyrene (SPS) resin and modified polyphenylene ether (m-PPE) resin, and
the metal magnetic powder is coated with one or more coating substances selected from dicarboxylic acid, dicarboxylic acid anhydride and a derivative thereof so that a part or the whole part of a surface of the metal magnetic powder is coated.

3. A magnetic compound, comprising:
a metal magnetic powder; and
one or more resins selected from syndiotactic polystyrene (SPS) resin and modified polyphenylene ether (m-PPE) resin,
wherein the metal magnetic powder is coated with one or more coating substances selected from dicarboxylic acid, dicarboxylic acid anhydride and a derivative thereof in a coating step, and
content of the resin is 21 mass % or more.

4. A magnetic compound, comprising:
a metal magnetic powder; and
a resin,
wherein the resin is one or more resins selected from syndiotactic polystyrene (SPS) resin and modified polyphenylene ether (m-PPE) resin, and
the metal magnetic powder is coated with one or more coating substances selected from dicarboxylic acid, dicarboxylic acid anhydride and a derivative thereof in a coating step.

5. The magnetic compound according to claim 1, wherein the metal magnetic powder is formed so that a part or the whole part of the surface of the metal magnetic powder is coated with one or more coating substance selected from phthalic acid, maleic acid, phthalic anhydride, maleic anhydride, and a derivative thereof,
wherein the term “derivative” as used herein refers to a compound that has been modified to such an extent that it does not significantly alter a structure or properties of a parent body, such as introduction of a functional group, oxidation, reduction, substitution of atoms, and “substitution of atoms” includes substances whose ends are replaced with alkali metals and made soluble.

6. The magnetic compound according to claim 5, wherein a measured value of carbon obtained by a high-frequency combustion method in a metal magnetic powder composite containing the metal magnetic powder and the coating substance is 0.1 mass % or more and 10 mass % or less.

7. The magnetic compound according to claim 5, wherein the number of carbon atoms contained in one or more chemical structures selected from phthalic acid, phthalic anhydride, maleic acid, maleic anhydride, and a derivative thereof constituting the coating substance is 4 or more and 20 or less.

8. The magnetic compound according to claim 1, wherein when the magnetic compound is made by containing 30 Vol % of the metal magnetic powder composite prepared by adding 5 parts by mass of one or more substance selected from the phthalic acid, maleic acid, phthalic anhydride, maleic anhydride, and the derivative thereof to the resin, with respect to 100 parts by mass of the metal magnetic powder, a real part μ′ of magnetic permeability at a measurement frequency of 2 GHz is 1.5 or more and tan δ μ and tan δ ε are 0.05 or less.

9. The magnetic compound according to claim 1, wherein when the magnetic compound is measured at intervals of 0.05 GHz in a range of 0.75 GHz or more and 1.0 GHz or less, a standard deviation of the real part μ′ of the magnetic permeability and the real part ε′ of the dielectric constant is 0.01 or less.

10. A magnetic compound comprising:
a metal magnetic powder; and
one or more resins selected from syndiotactic polystyrene (SPS) resin and modified polyphenylene ether (m-PPE) resin,
wherein content of the resin is 21 mass % or more, and
when the magnetic compound is made by containing 30 vol % of a metal magnetic powder composite composed of the metal magnetic powder and one or more coating substances selected from dicarboxylic acid, dicarboxylic acid anhydride and a derivative thereof, a real part μ′ of a magnetic permeability at a measurement frequency 2 GHz shows 1.5 or more and tan δμ and tan δε show 0.05 or less.

11. An antenna composed of the magnetic compound of claim 1.

12. The magnetic compound according to claim 1, wherein the magnetic compound is obtained by mixing a metal magnetic powder and at least one of phthalic acid, phthalic anhydride, maleic acid, maleic anhydride, and a derivative thereof to form a metal magnetic powder composite, and thereafter kneading with resin.

13. An electronic device comprising an antenna composed by the magnetic compound of claim 1.
